(19) United States
(12) Patent Application Publication
(10) Pub. No.: US 2015/0067153 A1
(43) Pub. Date: Mar. 5, 2015

(54) REMOTE MONITORING OF DATA FACILITY IN REAL-TIME USING WIRELESS SENSOR NETWORK

(71) Applicant: Kentucky State University, Frankfort, KY (US)

(72) Inventors: Siddhartha Bhattacharyya, Cedar Rapids, IA (US); Chi Shen, Lexington, KY (US); Dalton Jantzen, Payneville, KY (US)

(21) Appl. No.: 14/471,864

(22) Filed: Aug. 28, 2014

Related U.S. Application Data
(60) Provisional application No. 61/870,920, filed on Aug. 28, 2013.

(51) Int. Cl. H04L 12/26; H04W 4/00

(52) U.S. Cl. CPC H04L 43/04; H04W 4/005
USPC 709/224

(57) ABSTRACT

A method of monitoring a status of one or more computing devices in a computing system environment includes deploying a sensor network including a plurality of sensors to monitor multiple operating parameters of one or more computing devices of said computing system environment, each sensor being associated with one of said one or more computing devices. A base station computing device collects operating parameter data for the computing devices and analyzes the operating parameter data to (a) predict a failure of said one or more computing devices and/or (b) identify a fault condition of said one or more computing devices. Computing device operating parameters monitored include one or more of an operating temperature, a vibration, a cooling air flow rate, and a battery charge level. Monitoring systems for use in the method are disclosed.

This utility application claims priority to U.S. Provisional Application Ser. No. 61/870,920 filed Aug. 28, 2013, the contents of which are expressly incorporated by reference as if fully set forth herein.

### FIELD OF THE INVENTION

Generally, the present invention relates to methods and systems for monitoring computing systems. Particularly, it relates to a hardware-based method for monitoring computing systems such as server farms utilizing a sensor network. The sensors transmit data to at least one base station. The base station utilizes predictive algorithms analyzing multiple streams of data representing device operating parameters which are acquired by the sensors to determine device failure or impending failure.

### COPYRIGHTED MATERIAL

A portion of the disclosure of this patent document contains materials to which a claim of copyright protection is made. The copyright owner has no objection to the reproduction by anyone of the patent document or the patent disclosure as it appears in the U.S. Patent and Trademark Office patent files or records, but reserves all other rights with respect to the copyrighted work.

### BACKGROUND OF THE INVENTION

Conventional data facilities such as server farms, data centers, and the like house a variety of data processing and storage equipment for performing data storage and computing tasks. Other examples include hosted web servers, Internet services, and other enterprise services. Device failure is an ongoing problem, potentially resulting in catastrophic loss of data. Therefore, monitoring of such data facilities is required to ensure that the data processing and storage equipment is performing at specification, and that no elements of the data processing and storage equipment are failing or in danger of imminent failure. Significant manpower is required to perform such monitoring if done manually.

Presently automated monitoring of computing devices such as servers is conventionally done using software for monitoring performance characteristics like workload and rate of process execution. However, hardware solutions are typically significantly more robust than software. In turn, as is known, software is prone to failure due to corruption such as by viruses, hacking, etc., and periodically requires updating which can be a significant expense.

In the case of automated monitoring of data facilities to identify actual or potential device failure, it is also known to monitor such parameters as device temperature, data facility temperature, etc. to determine whether a device is failing or at risk of failing. However, a simple change in a particular parameter is not necessarily symptomatic of failure. For example, modern computing devices can experience a range of temperatures during periods of increasing/decreasing workloads, and yet not be failing or at risk of failing. A monitoring system which interprets, for example, a change in temperature deviating from an established “normal” temperature or range of temperatures as a failure or risk of failure may in fact be issuing a false positive for device failure.

There accordingly remains a need in the art for methods for monitoring computing devices in data facilities, to identify devices failing or at risk of failure without incorrectly diagnosing changes in particular measured parameters as indicative of failing devices. In particular, improved methods and systems for identifying computing devices that are failing or at risk of failure which consider a variety of device parameters and interpret deviations in same are desirable. Any improvements along such lines should further contemplate good engineering practices, such as relative inexpensiveness, stability, ease of implementation, low complexity, security, unobtrusiveness, etc.

### SUMMARY OF THE INVENTION

The above-mentioned and other problems become solved by applying the principles and teachings associated with the hereinafter-described methods and systems for remote monitoring of computing systems. The invention is suited for monitoring computing device health in a variety of data facilities, including server farms, data centers, and the like. Broadly, the invention provides improvements in monitoring capability for data facilities by monitoring a plurality of operating parameters to ascertain a failure and/or a fault condition of one or more computing devices in the data facility.

In one aspect, a computing system environment, a method of monitoring a status of a computing device in a computing system environment such as a data facility is provided, including deploying a sensor network comprising a plurality of sensors to monitor multiple operating parameters of one or more computing devices of the data facility. Each sensor is associated with one of the one or more computing devices. A base station computing device collects operating parameter data for the one or more computing devices and analyzes the data to (a) predict a failure of the one or more computing devices and/or (b) identify a fault condition of the one or more computing devices. Operating parameters of the computing devices which are monitored include an operating temperature, a vibration, a cooling air flow rate, and monitoring a battery charge level of said one or more computing devices. One or more of the operating parameters may be monitored over a predetermined time period to reduce false positive indications of failure/fault.

Collected data are sent to a base station computing device which may be remotely located from the monitored computing devices/sensor network. The data are analyzed and various predictive algorithms applied to correlate physical signatures derived from the operating parameters of the monitored computing devices to computing device failure/fault conditions. An alert, such as an email, text message, or other communication may be sent to an operator from the base station computing device when a failure and/or fault condition is detected.

In another aspect, a monitoring system for determining a health status of one or more computing devices in a computing system environment is provided, comprising a computing system environment including a plurality of computing devices and a monitoring system including a sensor network composed of a plurality of sensors and a base station computing device including at least one processor and at least one memory. The sensor network monitors multiple operating parameters of the computing devices and generates operating parameter data which are sent to the base station computing device. The base station computing device analyzes the operating parameter data according to the methods summarized above to identify a failure and/or a fault condition of one or more computing devices of the plurality of computing devices.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 depicts a monitoring sensor network according to the present disclosure monitoring a server farm;

FIGS. 2a and 2b show particular embodiments of sensors for use in the sensor network;

FIG. 3 is a flow chart for data flow through sensors according to the present disclosure;

FIGS. 4a, 4b, and 4c show details of sensors according to the present disclosure;

FIG. 5 is a flow chart for data collection and display according to the present disclosure;

FIG. 6 shows a representative decision tree for determining a failure and/or fault condition of a computing device according to the present disclosure; and

FIG. 7 shows a representative embodiment of a Web page displaying data collected by the sensor network to a user.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and systems for continuous optimization of computing resource allocation are hereinafter described.

The present disclosure describes a Wireless Sensor Network (WSN) involving the integration of wireless sensors that are networked with each other and with a base station for data acquisition. The sensors collect data representative of external physical operating parameters of computing devices. Data acquired by the base station are processed according to certain algorithms to interpret various measured computing device parameters as indicative of the “health” of one or more computing devices with which the sensors are associated. The WSN can be deployed in any data facility, such as a server farm, a data center, a network operating center, etc. to monitor the various computing devices contained therein. The data collected from the external monitoring of the WSN allows a user to determine if a particular server or a group of servers in a cluster is malfunctioning. Alerts are generated based on the changing dynamics of the servers being monitored if abnormal situations are encountered. Predictive analytics applied to the acquired data may in turn allow preventive maintenance and thus proactively prevent losses incurred due to failing servers.

The present system acquires multiple streams of data from the networked sensors representative of various external computing device parameters. This increases the precision and reliability of the prediction algorithm. In embodiments, a data fusion algorithm defines a baseline range for a healthy computing device, providing a baseline against which devices that are failing or at risk of failure can be compared. This involves combining relevant weighted parameters to identify “normal” behavior. In turn, a framework is provide for diagnosing computing device failure or risk of failure by monitoring physical “signatures” of the devices and comparing to the determined baseline. Variables included in the monitored physical signatures include one or more of temperature, airflow, vibration, and battery capacity. Variables such as time, humidity, and others are also contemplated.

In embodiments, “off the shelf” sensors are be deployed in data facilities to be monitored. The sensors acquire the appropriate data and transit same to a base station or stations, being one or more computing devices including executable instructions for implementing the predictive analytics which will be described in greater detail below. This allows the prediction of health of each server being monitored. The information is displayed in real or near-real time (relative to collection from the one or more monitored computing devices) to a user.

In embodiments, a sensor node or mote is used in the described sensor network. A mote is a node in a wireless sensor network that is capable of performing some processing, gathering sensory information, and communicating with other connected nodes and/or with a computing device in the network. The main components of a mote are a controller, a transceiver, external memory, a power source, and one or more sensors. The controller performs task, processes data, and controls functionality of other components of the sensor node. Example controllers include microcontrollers, microprocessors, digital signal processors, FPGAs, and ASICs. The transceiver performs transmitter/receiver functions, communicating with other nodes/computing devices using technologies such as ISM band, radio frequency (RF), optical communications such as laser technology, and infrared. Without intending any limitation, most commonly on-chip memory of a microcontroller and Flash memory are used for external memory, although other memory such as off-chip RAM is contemplated. The mote sensors are hardware devices that produce a measurable response to a change in a physical condition such as temperature, airflow, vibration, etc.

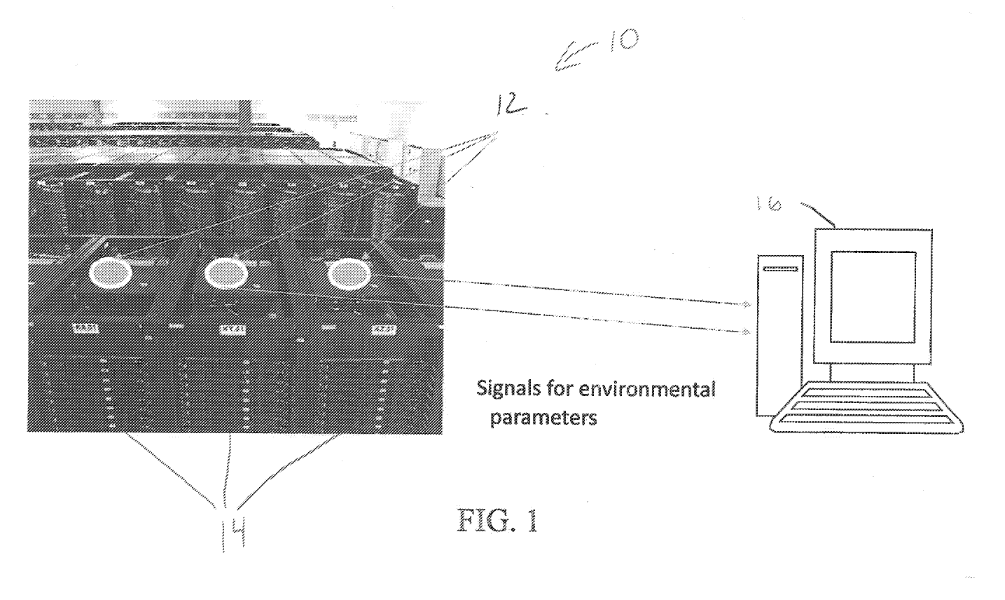

FIG. 1 shows a representative topology of a monitoring system 10, including a sensor network comprising a plurality of sensors 12 deployed on servers 14 of a server farm according to the present disclosure. The sensors 12 collect appropriate data for routing to a base station 16 for analysis. Depending on the proximity of the sensors 10 to the base station 16 the sensors 12 may transmit data directly to the base station 16 or may transmit data to a nearest cluster head (not shown) for transmission to the base station 16. The data collected are not available to the Operating System of the server(s) being monitored or to any functioning program of the server(s) being monitored, and likewise the monitoring system does not access any functioning program of the server(s) being monitored. Advantageously, the monitoring system does not interfere with the performance or process execution by the servers 14, or create any risk of data corruption.

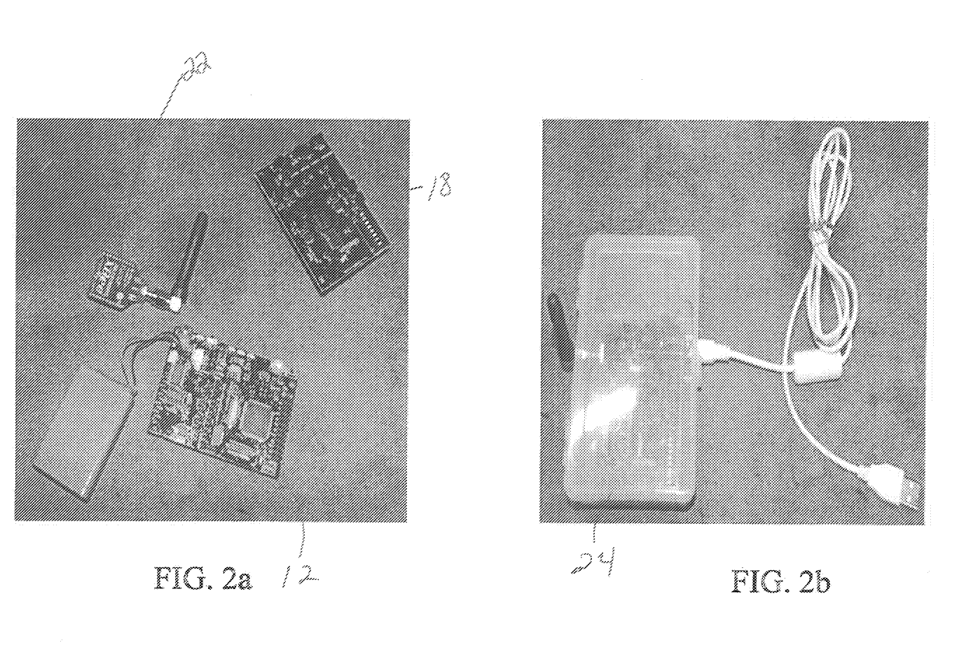

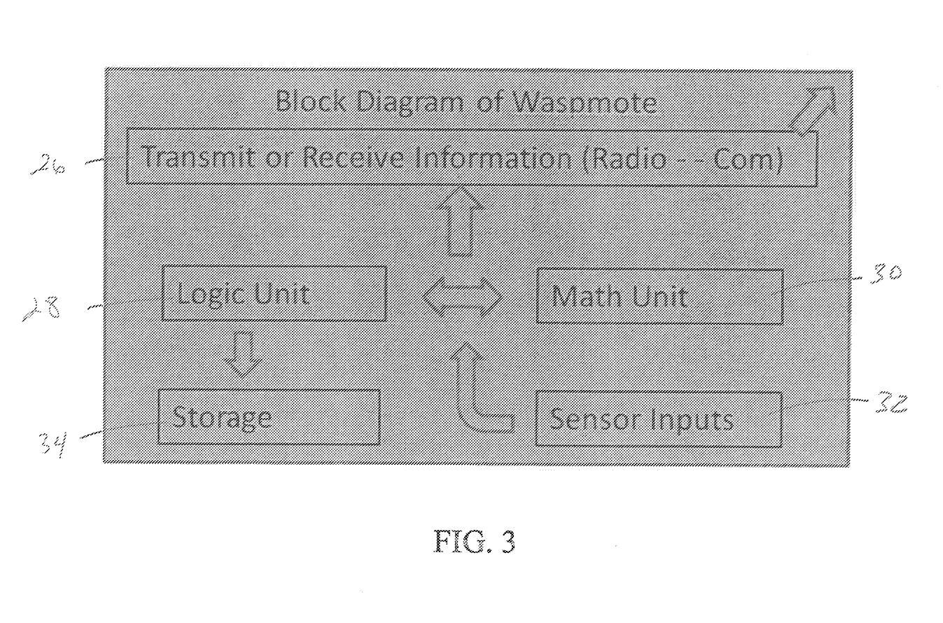

An example sensor 12 is shown in FIG. 2a. This figure also shows an event board 18 and a transceiver module 22 to transmit data. FIG. 2b shows the sensor 12 of FIG. 1a packaged in a housing 24 to be deployed for monitoring. In an embodiment, the Waspmote sensor (Libelium Comunicaciones Distribuidas S. L., Zaragoza, Spain) was used to provide the sensor network 10. However, it will be appreciated that other sensor designs are contemplated for use in the disclosed methods and systems. For example, the Arduino MOTE is very similar in construction and can use the same programming interface and programming language, and can have the required components hardwired to its board.

FIG. 3 shows a block diagram of the data flow through the sensor 12. Advantageously, the programming language system of the Waspmote utilized in the disclosed embodiment for sensor 12 is an open source language. A UART (Universal Asynchronous Receiver/Transmitter) chip 26 of the mote moves data in and out from the collection point of sensor 12. A logic unit 28 applies logic rules to the collected data and a math unit 30 applies math rules to the collected data. It will be appreciated that the sensor 12 is capable of not only collecting data but also possesses enough processing power to do simple logic and mathematical operations to the collected data before moving that data to the UART section 26 for external collection. The sensor inputs 32 allow various signals from external stimuli to be interpreted in a logical fashion and the programming of the MOTE applies specified rules and operations to the collected data, which may be temporarily stored in storage unit 34 if necessary (for example, if communication with the base station 16 is temporarily lost). These are described in detail below.

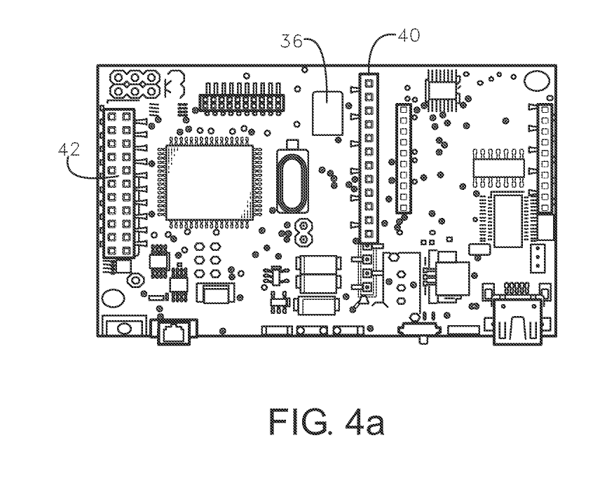

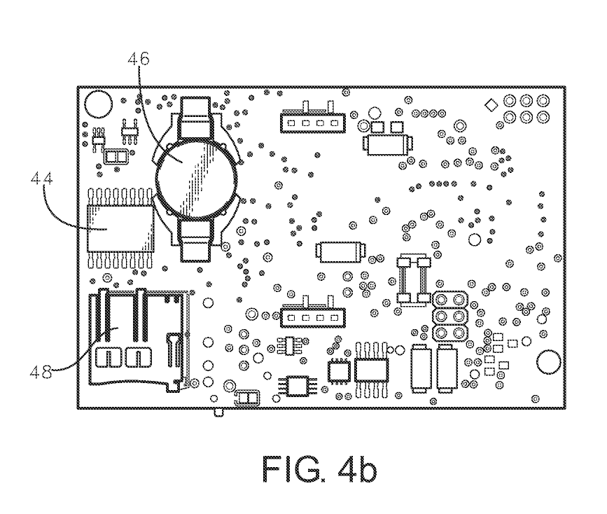

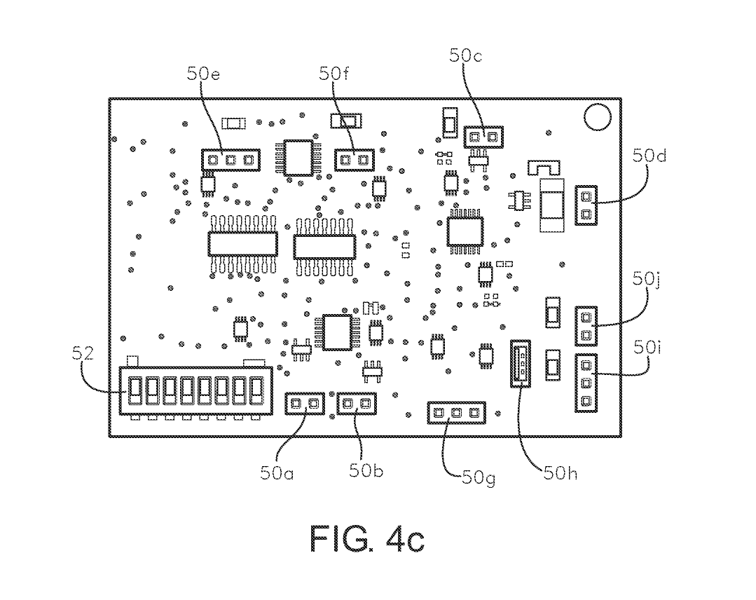

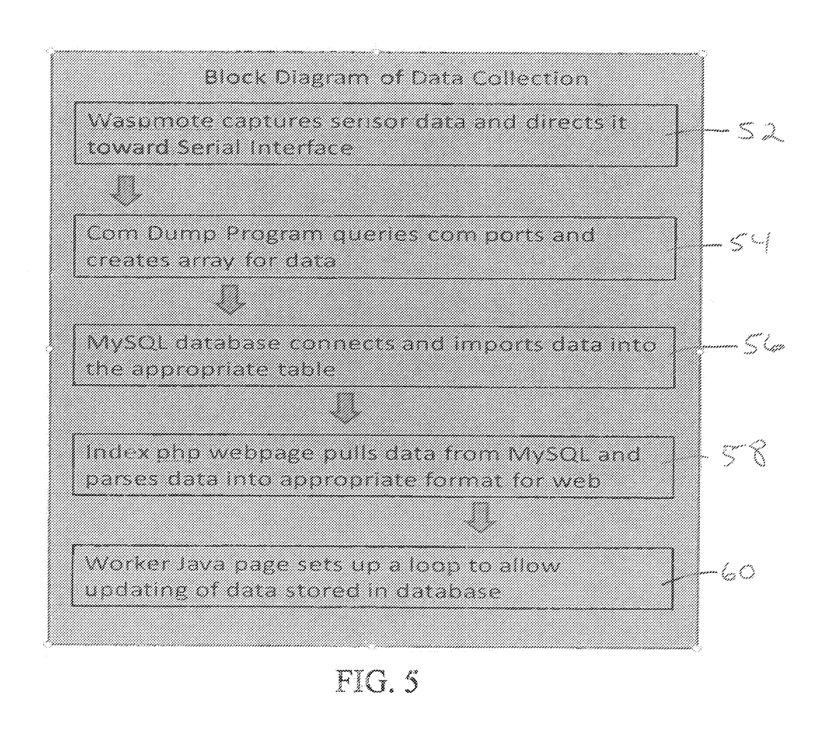

In FIG. 4a a representative architecture of a sensor 12 is illustrated. The Waspmote board used as sensor 12 has a built in accelerometer 36 (for vibration analysis) and temperature sensor 38 (see FIG. 4b). The UART sockets 40 and the I/O inputs 42 were used to attach additional sensor inputs by attaching the Events Board 18 shown in FIG. 4b.

In FIG. 4b, the bottom side of the sensor 12 board is shown. The bottom side of the board contains the real time clock mechanism 44, the backup battery 46 and the mini SD card slot 48 for extra storage space. The Waspmote is capable of storing data even if it is unable to communicate with the gateway using the SD card. In FIG. 4c, the Events Board 18 is illustrated and various components are labeled. Each individual socket 50ₐ . . . 50ⱼ is capable of being a separate input for data. The Manual Switch 52 can be used to disable any of the inputs to conserve power.

In FIG. 5, the basic outline of the data collection is presented. Data collection 52 starts with a programmed sensor 12 connected to a server 14 (not shown) to be monitored. A representative code for programming the sensor 12 is included herein in Code Appendix A (incorporated herein by reference). The configuration code for sensor 12, representatively termed Waspmote Code, instructs the sensor 12 to gather data from a based on the mote identification number. In the depicted embodiment, the code further instructs the sensor 12 to report the battery level, the temperature (in the depicted embodiment, the hardware functions accurately in a range of temperatures of from about −14° F. to about 149° F.), the status of an external sensor called the BEND SENSOR, and the X, Y, and Z coordinates of the built-in accelerometer 36 (to allow calculation of a vibration parameter for the monitored computing device). The sensor 12 transmits data to the base station 16 (which may be a Web Server) by way of a com port either using a data cable or a wireless collection point.

A collection program termed ComDump Program (included herein in Code Appendix B and incorporated herein by reference) collects the data in step 54. This program is installed on the Server and creates a query of the COM ports and also creates a 4 k array to be used as a buffer for the data from the MOTE. The ComDump program allows the user to pick the appropriate COM port and then creates the 4 k array buffer. Additionally, the ComDump program creates a connection to a MYSQL database and sets up a table for data collection. Once the program is executed the connections and data logging starts automatically and is collected in the database. This program could be started automatically by the operating system of the Server or could be run as a service to start with the computer.

Then the data from the ComDump program is collected by a database and is imported into the appropriate table for storage and processing (step 56). A php page pulls data from the database and displays the data in the desired format on a web page. A java worker program (discussed below) causes the page to be refreshed periodically to display updated information. The collection of sensors 12 and the communication module used can also be deployed to monitor the health of various machines in power plants, manufacturing floors, air conditioning and heating units.

All of these data are exported from the sensor 12 through a serial port commonly referred to as a COM port. The sensor 12 exports the data in a simulated comma delimited file. The data file is created by the sensor 12 by printing the data then printing a comma. The final command creates a carriage return and completes one data package. The code also contains a section which pauses the data collection. Five seconds was selected as the initial data collection interval, although alternative intervals are contemplated. The sensor 12 is capable of sending data at faster or slower data rates. It will be appreciated that the monitored server 14 is completely isolated from the sensor 12 device and that no software, authorized or unauthorized, is installed on the monitored computer. There is no possibility of the monitoring machine to interfere or “leak” data from the monitored machine.

To successfully execute the operations of this project, it was necessary to create another computer to be used as a data gathering center. A Microsoft Windows 2008 Server platform was installed and configured, although other operating systems could be adapted to gather the data and so are contemplated for use herein. The data gathering computer (referred to as the Server) is installed and configured to receive the data through a COM (Serial) port. Serial communications have been developed for many decades and sending a stream of data one bit at a time is very efficient especially when dealing with small packets. The MOTE can be connected to the Server either physically via a USB (Universal Serial Bus) cable or non-physically with a wireless device.

In the depicted embodiment, a wireless device was available and used. The Xbee device (Digi International, Inc., Minnetonka, Minn.) is a wireless communication device which allows for very low power wireless communications. The Xbee device is connected to a USB port and the operating system of the Server creates the appropriate port and installs the Microsoft software. Dataflow of the process is illustrated in FIG. 5.

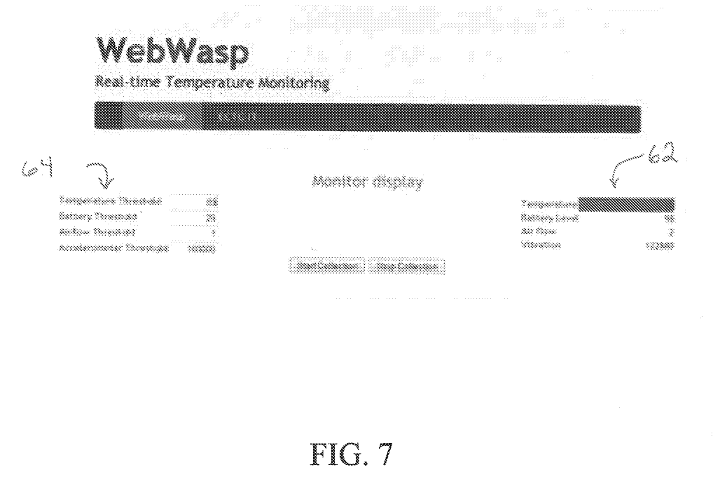

The data is available instantly on the Internet. The Server is also configured to be a Web Server and is connected to the Internet. The program we used to create the webpage by which the data are available on the Internet is referred to as the WebPage Code (included herein in Code Appendix C and incorporated herein by reference. A representative embodiment of a suitable Web page for displaying data to a user is provided in FIG. 7.

In this code, the data boxes are created and the general webpage is created (step 58). The webpage connects to the database running on the Server and pulls the latest data from the database and plugs the appropriate data into the appropriate boxes for reporting to the user. The webpage also does some manipulation to the data. The data are presented to the webpage in a raw form meaning that some of the data is directly usable, but some of the data must be interpreted. The temperature of the monitored computer is directly viewable and understandable by the layman. Raw data may be kept as collected or may be converted to more useful or desirable units. For example, temperature data may be converted from Fahrenheit to Celsius, or vice versa. Air flow data may be converted to any useful metric, such as cubic inches per second or cubic feet per minute. The data display area is generally indicated in FIG. 7 by ref. num. 62.

The accelerometer raw data are not so directly interpreted because the X, Y, and Z coordinates collected by the sensor 12 accelerometer 36 when viewed would not provide the desired effect of sensing vibration of the monitored computer. Therefore, the amplitude of the coordinates is calculated to characterize the vibration signature. The change of that number indicates a change in the relative position of the sensor 12, which is viewed or interpreted as vibration.

The webpage also contains an area (generally indicated in FIG. 7 by ref. num. 64) which is user customizable. This area allows the user to set a critical value or threshold for measured parameters (temperature, vibration, airflow, battery) that is compared to the data reported by the sensor 12. This can be noted visually by a user. More usefully, if the reported data drops outside of the user set range, the program automatically calls a subroutine and executes a command which sends a communication to the user. The program can be configured to send a text message, an email message, an IM, or any suitable communication to the user. It will be appreciated that the server must also configured to be a mail server for the feature of an automated email alert to function, which is well within the ability of the skilled artisan. The communication may be sent to any desired predetermined device(s) of the user, such as mobile device (cell phone, smartphone, tablet computer, laptop computer, PDA etc.) or other (desktop computer, gaming console, “smart” television, etc.).

At this point all of the data reported to user is static (meaning that unless the user manually refreshes the page the data will remain the same). This problem was solved by creating another program which automatically refreshes the page and loads the latest data from the database (step 60). This program is called the Worker Code (included herewith as Code Appendix D and incorporated herein by reference). The Worker Code automatically refreshes and reloads the webpage every 5 seconds. This code works outside of the user's notice simply because most of the data on page stays the same with the exception of the reported values.

From the data collected as described above, calculations were included to allow predicting the failure of a critical component. In particular, values for temperature, vibration and airflow were calculated in a manner such that each component was weighted. It will be appreciated by the skilled artisan that the weight of the individual component can be customized by the user to allow for individuality of applications. In one embodiment wherein temperature, airflow, and vibration were measured, equal weights were given to each measured parameter for testing purposes. That is, temperature counted as 33%, airflow counted as 33% and vibration counted as 33%.

In other embodiments, time may be included as a factor. The sensors 12 described herein use an internal clock for timing. This internal clock is used to add additional parameters for more accurate calculations for predictive failure. For example, when considering temperature as a predictive value, temperature alone does not provide a completely accurate failure prediction, since as is known temperature may vary normally for a server 14, such as during increased or decreased workload. Accordingly, time and airflow are included in the predictive analysis. Temperature rising and continuing to rise over a period of time triggers an alert, but temperature rise over a few minutes will not. In another scenario, the temperature rising and airflow decreasing will trigger an instant alert. Obviously the two parameters interacting simultaneously will have a multiplicative effect for our alerts (i.e. a rising temperature and a falling rate of airflow triggers the alert). In a similar fashion, a decrease in airflow over time which is indicative of a failing fan or a clogged filter will also trigger an alert.

The following is a table which demonstrates a representative set of parameter changes which may trigger a failing device alert.

| | | | | | Battery |
|---|---|---|---|---|---|
| Alert | Time | Temperature | Airflow | Vibration | Level |
| yes | — | — | — | — | <25% |
| yes | increase | increase | — | — | — |
| yes | — | increase | decrease | — | — |
| yes | — | — | increase | increase | — |
| No | — | increase | — | — | — |
| | | (<threshold) | | | |
| Yes | >threshold | — | — | increase | — |
| No | <threshold | — | — | increase | — |

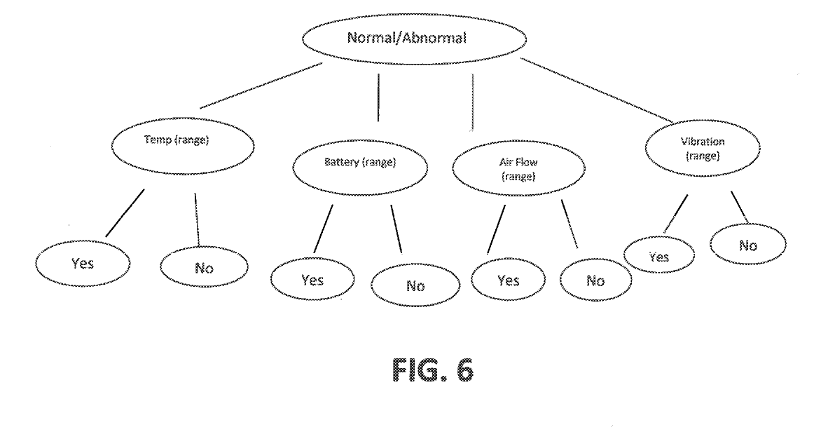

For data analysis, various methods known in data mining techniques are considered, such as without limitation classification models, clustering, and linear regression. These include a regression algorithm considering each variable (temperature, time, vibration, airflow, battery) as a continuous variable. The algorithm predicts one or more continuous parameters, such as temperature or airflow as these two are highly tied to each other. An association algorithm is used to find correlations between different attributes in a dataset, to analyze the relationships among the parameters such as for example, between temperature and vibration. If two variables are too high or too low (compared to a baseline) for a certain amount of time period, then the system may issue a failing device alert condition. A classification algorithm defines three types of device (server or other computing device) conditions: good, alert and failure. A representative decision tree determining a normal or abnormal server 14 is shown in FIG. 6. For each device parameter measured by the sensors 12 (temperature, airflow, vibration, battery), a separate determination is made whether the measured value falls within a normal range.

“Healthy” ranges are determined for each parameter, i.e. temperature, airflow, vibration, and battery strength. The skilled artisan will appreciate that these healthy ranges may have to be differently determined for servers 14 in different environments, as a same server disposed in a different data facility may have a differing range of conditions considered to be indicative of a “healthy” server. Association rules between measured parameters are set. For example, four “no's” according to the decision tree of FIG. 6 indicates that the server 14 has failed. “No's” for measured temperature and airflow parameters of server 14 may indicate that server 14 is failing.

Certain advantages of the invention over the prior art should now be readily apparent. The skilled artisan will readily appreciate that by the present disclosure a hardware-based system which does not interact or interfere with any hardware or software operations of a monitored computing device is provided, eliminating any risk of compromising or corrupting hardware or software of the monitored device. In turn, particular combinations of computing device operating parameters are monitored, reducing risk of “false positive” indications of device failure or a fault condition.

Finally, one of ordinary skill in the art will recognize that additional embodiments are also possible without departing from the teachings of the present invention. This detailed description, and particularly the specific details of the exemplary embodiments disclosed herein, is given primarily for clarity of understanding, and no unnecessary limitations are to be implied, for modifications will become obvious to those skilled in the art upon reading this disclosure and may be made without departing from the spirit or scope of the invention. Relatively apparent modifications, of course, include combining the various features of one or more figures with the features of one or more of other figures.

CODE APPENDIX A
Waspmote Code

/* Caution there may be spelling errors ahead */
void setup( )
{
USB.begin( );
RTC.ON( );
ACC.ON( );
}
void loop( )
}
/* the following code sets the accelerometer to zero and assures that
the accelerometer is properly calibrated */
byte check =ACC.check( ); //Should always be Ox3A
//Convert to Fahrenheit because we live in America and like accurate
readings ;-)
float f = ((RTC.getTemperature( ) * 9) / 5) + 32;
int x_acc, y_acc, z_acc
x_acc = ACC.getX( );
y_acc = ACC.getY( );
z_acc = ACC.getZ( );
/* Output to be collected by application running on the server currently
called com_dump at this time must be manually started but
could be put in auto start folder or run as a service*/
if ( check == 0x3A ){//Check the register, do not print if no data
//Print the identifier for this mote
USB.print(“Mote1”);//Add this motes MAC or Name to the string
USB.print(“,”);/ /Comma separator
//Print the temperature reported by the device
USB.print(f,DEC);//Add the temp to the string dropping the float portion
USB.print(“,”);/ /Comma separator
//Print the battery level
USB.print(PWR.getBatteryLevel( ),DEC);//Add battery level to the string
USB.print(“,”);//Comma separator
//Print the airflow
USB.print(“l00”);//Add the airflow to the string
USB.print(“,”);//Comma separator
//Print the XYZ values
USB.print(x_acc);//X
USB.print(“,”);
USB.print(y_acc);//Y
USB.print(“,”);
USB.print(z_acc);//Z
USB.printIn(“”);//Send print line to end the string
}
delay(5000);//Set the delay for serial data transfer this setting allows
for 5 seconds
}

CODE APPENDIX B
ComDump Code

using System,
using System.Collections.Generic;
using System.Linq;
using System.Text;
using System.IO.Ports;
using MySql.Data.MySqlClient;
namespace waspSerialTester1
{

class Program
{

static MySqlConnection mCon = null;
//Strings used for the connectin change these if you use a different sql setting
static string pword = “P@ssw0rd”;
static string tblname = “testwaspmote”;
private static void setup( ) {

//Establish the mysql connection
connectDB( );

}

.WriteLine(“PAUSE TO READ OUTPUT”);

Console.ReadLine( );

}
/*
* connectDB
* Establishes a connection to the MySQL server which results in a perpetual connection, be

sure to clean up!

* RETURNS
* void
*/
public static void connectDB( ) {

string

“ + dbname + “;” +

“UID=” + uid + “;” +
“PASSWORD=” + pword + “;”;

mCon =
{/*
* Attempt to establish a connection to the DB perpetually until the application closes,

```
  * this means we must take care when quitting the application to prevent memory
  leaks in
  * the application as well as leaks in MySQL with leaving connections open and losing
  * the handle on them.
  */
```

Console.WriteLine(“Establishing a connection with MySQL”);
mCon.Open( );

}
catch (Exception e) {

Console.WriteLine(e,ToString( ));

}

}
/*
* get Mote Data

| | |
|---|---|
| * The workhorse for our application, this function establishes a loop that will read | data |

* from the serial connection until it is closed. All data from the serial port is parsed
* and formatted for an INSERT SQL statement. Be aware that the data is somewhat
closely
* coupled from the mote to this application and then to the SQL server. Be sure to run
* the provided SQL scripts to build the default behavior for this application.
*/
public

//Make a little banner with the quickness
Console.WriteLine(“ ”);
Console.WriteLine(“Please enter a COM port from the list above and\r\n lets be case-

sensitive for testing ;-)”);

//Get the users choice of COM port and store it in a variable to use later
stng com = Console.Re( );
//Attempt to connect to the serial COM port
try
{

//Set the connection specific data

/*WRITE SOME DEBUG INFO TO CONSOLE*/

//Console.WriteLine(sqlString);//Debug strings to view the data sent from the

waspmote

}
//Attempt cleanup from the loop
( );
//This code will only run if the connection is no longer open
Console.WriteLine(“Connection to DB is lost, please restart this application to continue

processing.”);//Inform user

sp.Close( );//Clean-up
Console.Rine( );//Wait so user can see message

}
catch (Exception e)
{//Connection to COM port failed

Console.WriteLine(e.Message);

}

}
/*
* stringBuilderSQl
* takes in a string(txt) and converts the string to a properly formatted SQL INSERT

statement

* returns
* A string respresenting the correct SQL statement to insert data to MySQL
*/
private static string stringBuilderSQL(string txt)
{

string sqlOutput = “INSERT INTO ” + tblname +

“(mac,temp,battery,airflow,pos_x,pos_y,pos_z)VALUES(“;

string[ ] brokeString = txt.Split(‘,’);//dont use doube quoted strings
for (int | = 0; i < brokeString.Length; i++ )
{//Check for the MAC since it is a string we cannot do the same process of adding it to the

sqlstring

if (i == 0)//The MAC is stored as a string
{

sqlOutput +=“'” + brokeString[i] + “'”;

}
else//All other values are stored as integers
}

sqlOutput += “,” + i];

}

}
sqlOutput += ”)”;
return sqlOutput;

}

}

}

CODE APPENDIX C
WebPage Code (index.htm)

```
<!DOCTYPE HTML>
<head>
<meta charset=“utf-8”>
<title>WebWasp</title>
<link rel=“shortcut icon” href=“favicon.ico” type=“image/x-icon” />
<link rel=“stylesheet” href=“css/style.css”>
<script defer=“defer” src=“js/jquery-I.7.2.js” ></script>
<script defer=“defer” src=“js/worker.js” ></script>
</head>
<body>
<div id=“wrapper”>
<header id=“banner”>
    <h1><a href=“index.html”>WebWasp</a></h1>
    <h2>Real-time Temperature Monitoring</h2>
    <nav><ul>
      <li class=“active”><a href=“#”>WebWasp</a></li>
      <li><a href=“http://it.elizabethtown.kctcs.edu”>ECTC IT</a></li>
    </ul></nav>
</header>
    <aside id=“featured” class=“body”>
    <article>
    <hgroup>
        <h2>Monitor display</h2>
    </hgroup>
<!--
    <div class=“meter-wrap”>
    <div class=“meter-value” style=“background-color: #0a0; width:32%”>
    <div class=“meter-text”>
      <iframe id=“hiddenContent” width=“200” height=“25”
style=“position:absolute;overflow:hidden;” frameBorder=“0”></iframe>
      </div>
      </div>
    <INPUT TYPE=“button” VALUE=“Update”
    onClick=“loadOuter(‘honkyhonky.txt’)”>
  </div>
-->
<!--Currently there are no styles associated with the following display data -->
  <div id=“ui”>
    <div id=“alertPanel”>
      <label>Temperature Threshold<input id=“alertTemp” type=“text” /></label>
      <label>Battery Threshold<input id=“alertBatt” type=“text” /></label>
      <label>Airflow Threshold<input id=“alertAirf” type=“text” /></label>
      <label>Accelerometer Threshold<input id=“alertAcce” type=“text” /></label>
    </div>
    <div id=“displayPanel”>
      <div>Temperature <span id=“displayTemp”> The temp</span></div>
      <div>Battery Level <span id=“displayBatt”> The battery</span></div>
      <div>Air Flow <span id=“displayAirf”> The airflow</span></div>
      <div>Vibration <span id=“displayAcce”> The accelerometer</span></div>
</div>
<!--The input boxes used to gather data from the user and compare with report values
for simulating alarms/notifications -->
<div id=“inputPanel”>
    <input type=“button” value=“Start Collection” onclick=“startColiection( )” />
    <input type=“button” value=“Stop Collection” onclick=“stopColiection( )” />
    </div>
  </div>
  <br />
</article> </aside>
    <footer id=“contentinfo” class=“body”>
    <address id=“about” class=“vcard body” style=“height: 463px”>
        <span class=“primary”>
            <strong><a href=“http://it.elizabethtown.kctcs.edu”
    class=“fnurl”>Dalton Jantzen</a></strong>
            <span class=“role”>Professor, ECTC</span>
    <span class=“role”>
        <img src=“img/Dalton.jpg” alt=“Dalton Jantzen” class=“photo”
height=“232” width=“167” style=“margin-left: 5px; margin-top: 17px” /></span>
        </span>
        <span class=“bio” style=“height: 381px”>&nbsp;<span
class=“bio2”><span style=“font-size:10.5 pt;
line-height:ll5%;font-family:&quot;Trebuchet MS&quot;,&quot;sans-serif&quot;;mso-
fareastfont-family:
Calibri;mso-fareast-theme-font:minor-latin;mso-bidi-font-family:&quot;Times New
Roman&quot;;
mso-bidi-theme-font:minor-bidi;color:#000305;mso-ansi-language:EN-US;
mso-fareast-language:EN-US;mso-bidi-language:AR-SA”>Welcome to my Thesis
    Project.&nbsp; I am a graduate student at Kentucky State University.&nbsp; I
teach
    Information Technology at Elizabethtown Community and Technical
    College.&nbsp; This is my 20th year at the college.&nbsp; I received my
education
    degree and undergraduate degree from Western Kentucky University.<span
style=“mso-spacerun:yes”>
    </span>I was a small business owner prior to my teaching career.<span
style=“mso-spacerun:yes”>&nbsp;
    </span>My business was primarily concerned with consumer based electronic
    repair.<span style=“mso-spacerun:yes”>&nbsp; </span>I started this project with
    an idea and a long search for the proper equipment.&nbsp; One day, I was in my
    Cisco lab and heard a computer fan that obviously had issues.<span style=“mso-
    spacerun:yes”>&nbsp; </span>The computer that had the
    defective fan was still operational, but near failure.<span style=“mso-
spacerun:yes”>&nbsp;
    </span>Of course, software monitoring the computer would be of little use.
    <span style=“mso-spacerun:yes”>&nbsp;</span>The computer was still
    operational.<span style=“mso-spacerun:yes”>&nbsp; </span>I spent several
    weeks looking for equipment to implement this project.&nbsp; I decided that the
    major flaw in most computer monitoring software was: the computer.
    My hardware monitors the computer independently from the OS. My
‘Mote&quot; is
    attached to a computer on the Internet.&nbsp; In this demonstration, we
    monitor temperature, airflow, the battery on the mote and the
    accelerometer on the mote.&nbsp; The first three are self-explanatory, but
    why monitor the accelerometer?&nbsp;
    <span style=“font-size: 10.5pt; line-height: 115%; font-family:&quot;Trebuchet
MS&quot;,&quot;sans-serif&quot;; mso-fareast-font-family: Calibri; mso-fareast-theme-
font: minor-latin; mso-bidi-font-family: &quot;Times New Roman&quot;; mso-bidi-theme-
font: minor-bidi; color: #000305; mso-ansi-language: EN-US; mso-fareast-language:
EN-US; mso-bidi-language: AR-SA”>
        The accelerometer will indicate vibration on the computer. Under the
        hood, this project will monitor a server and allow a person to remote
        monitor from the web.</span></span></span></span></address>
</footer>
</div>
</body>
</html>
```

CODE APPENDIX D
Worker Code

```
/*
*This file will handle setting a timer for data retrieval, calling worker PHP
*files to further process server-side data, comparing user submitted values with
*collected data. let's get started!
*
*DANGER, DANGER, Will Robinson!
*The functionality ofthis script uses an infinite loop :-)
*/
//Set the delay for data retrieval requests, remember these calls are
//asynchronous so they may not return in a particular order
var mDelay = 2000;//Time is in milliseconds
var mCollect = false;//Collection flag for stopping our infinite loop
var mTimeout = null;//Variable to store timeout in
function t( ){
      //Do the actual work
      //TODO get MySQL Data stored by the broker code
      $.ajax({
    url:“../worker.php?function=getlastRecord”,
    contentType:“text/html”,
    statusCode: {
      404: function( ){
    alert(“Page not found!”);
  },
  500: function( ){
  }
  }).done(function( data ){
    //Data is an associative array JSON encoded
    //Put the new data in the display fields
    car record =JSON.parse(data);
    $(‘#
    if( Number($(‘#alertTemp’).val( )) <= Number($(‘#displayTemp’).text( ))){
        $(‘#displayTemp’).css(‘background-color’,‘red’);/ /Code to run for visual
  alert
} else {
    $(‘#displayTemp’).css(‘background-color’,‘white’);//Code to run when alert is
  cleared
//check the temperature
if( Number($(‘#).text( ))){
    $(‘#displayBatt’).css(‘background-color’,‘red’);//Code to run for visual alert
} else {
    $(‘#displayBatt’).css(‘background-color’.‘white’);/ /Code to run when alert is
  cleared
    alert)”The server erred”);
    }//check the battery level
    if( Number($(‘#alertAirf’}. val( )) >= Number($(‘#displayAirf’}.text( ))}{
        $(‘#displayAirf’).css(‘background-color’.‘red’);/ /Code to run for visual alert
    } else {
          $(‘#displayAirf’).css(‘background-color’,‘white’);//Code to run when alert is
cleared
      }//check the airflow
    /*TODO rethink the way we handle*/
    /* if( Number($(‘#alertAcce’).val( )) <= Number($(‘#displayAcce’).text( ))){
      $(‘#displayAcce’).css(‘background-color’,‘red’);//Code to run for visual alert
    } else {
      $(‘#displayAcce’).css(‘background-color’.‘white’);//Code to run when alert is
    cleared
    }//check the accelerometer*/
  });
  //Call myself to create infinite loop
  mTimeout = setTimeout(“t( )”, mDelay);//A little bit of recursion to keep the loop going
}
//Begins the collection routine
function startCollection( ){
      if(!mCollect){
            //alert(“Starting...”);
            mCollect = true;
            mTimeout = setTimeout(“t( )”, mDelay);
      }
  }
  //Halts the collection routine
function stopCollection( ){
if(mCollect){
  //alert(“Stopping...”);
  clearTimeout(mTimeout);
  mCollect = false;
    }
}
```

1. In a computing system environment, a method of monitoring a status of a computing device, comprising:
deploying a sensor network comprising a plurality of sensors to monitor multiple operating parameters of one or more computing devices of said computing system environment, each sensor being associated with one of said one or more computing devices;
by a base station computing device including at least one processor and at least one memory, collecting operating parameter data for said one or more computing devices; and
analyzing said operating parameter data to (a) predict a failure of said one or more computing devices and/or (b) identify a fault condition of said one or more computing devices.

2. The method of claim 1, including monitoring an operating temperature of said one or more computing devices.

3. The method of claim 1, including monitoring a vibration of said one or more computing devices.

4. The method of claim 1, including monitoring a cooling air flow rate of said one or more computing devices.

5. The method of claim 1, including monitoring a battery charge level of a battery of said one or more computing devices.

6. The method of claim 1, including monitoring operating temperature, cooling air flow and vibration of a computing device in said computing system environment.

7. The method of claim 5, including completing said monitoring over a predetermined time frame.

8. The method of claim 7, wherein said base station is remotely located from said sensor network.

9. The method of claim 8, including sending an alert from said base station to an operator when said predicted failure and/or fault condition is identified.

10. The method of claim 9, including identifying said fault condition from operating parameters selected from a group consisting of a computing device battery charge value falling below a predetermined threshold value, an increase in computing device operating temperature in an amount above a predetermined threshold value, a decrease in computing device cooling air flow rate below a predetermined threshold value, an increase in computing device vibration above a predetermined threshold value, and combinations thereof.

11. The method of claim 9, including identifying said fault condition from operating parameters selected from a group consisting of a computing device battery charge level falling below a predetermined threshold value, an increase in computing device operating temperature in an amount above a predetermined threshold value for more than a predetermined period of time, an increase in computing device operating temperature in combination with a decrease in computing device cooling air flow rate, a decrease in computing device air flow rate in combination with an increase in computing device vibration, an increase in computing device vibration above a threshold value for more than a predetermined period of time and combinations thereof.

12. The method of claim 9, including identifying said failure condition from a computing device battery charge level falling below a predetermined threshold value, an increase in computing device operating temperature in an amount above a predetermined threshold value for more than a predetermined period of time, a decrease in computing device cooling air flow rate, and an increase in computing device vibration above a threshold value for more than a predetermined period of time.

13. The method of claim 1, including using a wireless sensor network comprising a plurality of sensors for wirelessly transmitting operating parameter data to the base station.

14. The method of claim 1, including monitoring operating parameters of the one or more computing devices of the computing system environment without any sensor interference or interaction with computing device operation or computer program product operation of said one or more computing devices.

15. A monitoring system for determining a health status of one or more computing devices, comprising:
a monitoring system including a sensor network comprising a plurality of sensors, each sensor associated with one of a plurality of computing devices deployed in a computing system environment; and
a base station computing device including at least one processor and at least one memory in communication with said sensor network;
wherein said sensor network monitors multiple operating parameters of said computing device, generates operating parameter data, and sends said operating parameter data to said base station computing device;
further wherein said base station computing device analyzes said operating parameter data to identify a failure and/or a fault condition of one or more computing devices of said plurality of computing devices.

16. The computer system environment and monitoring system of claim 15, wherein said sensor network includes a sensor selected from a group consisting of an accelerometer, a temperature sensor, a cooling air flow rate sensor, a battery charge level sensor and combinations thereof.

17. The computer system environment and monitoring system of claim 15, wherein said plurality of sensors of the sensor network communicate with the base station computing device by wireless means.
